(19) United States
(12) Patent Application Publication
(10) Pub. No.: US 2026/0164403 A1
(43) Pub. Date: Jun. 11, 2026

(54) METHODS FOR TRANSMISSION OF ENHANCED POSITIONING SIGNALS

(71) Applicant: InterDigital Patent Holdings, Inc., Wilmington, DE (US)

(72) Inventors: Javier Lorca Hernando, Madrid (ES); Arman Shojaeifard, London (GB)

(73) Assignee: InterDigital Patent Holdings, Inc., Wilmington, DE (US)

(21) Appl. No.: 19/150,126

(22) PCT Filed: Feb. 12, 2024
(86) PCT No.: PCT/US2024/015347

§ 371 Date: Jul. 22, 2025

Related U.S. Application Data
(60) Provisional application No. 63/446,406, filed on Feb. 17, 2023.
(60) Provisional application No. 63/455,738, filed on Mar. 30, 2023.

(51) Int. Cl. H04W 64/00; H04B 17/318; H04L 5/00

(52) U.S. Cl. CPC H04W 64/006; H04B 17/318; H04L 5/0051

(57) ABSTRACT

A wireless transmit receive unit (WTRU) may receive configuration information. The configuration information may indicate one or more parameters for a first type of positioning reference signals (PRSs); one or more parameters for a second type of PRSs; and/or a number of consecutive symbols configured for velocity measurements associated with the first type of PRSs. The WTRU may perform positioning measurements for each of the first type of PRSs and the second type of PRSs. The WTRU may determine an estimated velocity associated with the WTRU based on a frequency modulated (FM) noise estimation associated with the first type of PRSs over the number of consecutive symbols indicated by the configuration information. The WTRU may send a feedback report comprising the positioning measurements for each of the first type of PRSs and second type of PRSs and an indication of the estimated velocity.

### CROSS-REFERENCE TO RELATED APPLICATIONS

This application claims the benefit of U.S. Provisional Patent Application No. 63/446,406, filed on Feb. 17, 2023; and U.S. Provisional Patent Application No. 63/455,738, filed on Mar. 30, 2023, the entire contents of which are incorporated herein by reference.

### BACKGROUND

In addition to serving traffic towards/from wireless transmit/receive units (WTRUs), providing accurate and/or robust positioning is becoming increasingly important in many applications. Global navigation satellite systems (GNSS) may provide centimeter (cm)-level accuracy outdoors. However, many GNSS may suffer from multipath in urban environments as well as poor signal-to-noise (SNR) ratio in the already polluted industrial, scientific, and medical (ISM) bands. Moreover, GNSS procedures may require good outdoors visibility to more than one satellite and/or do not work indoors. In contrast, cellular-based positioning may benefit from the better quality and access conditions of the licensed bands while exploiting the already deployed mobile communications infrastructure.

Downlink (DL) positioning reference signals (DL PRS) and/or uplink (UL) sounding reference signals for positioning (UL SRSp), may enable a positioning accuracy of less than 3 meters (m) indoor and/or less than 10 m outdoor in general commercial use cases. The higher accuracy requirements set by new industry verticals, with less than 1 m for commercial use cases and/or less than 0.2 m for Industrial Internet of Things (IIoT) use cases may be needed. Other positioning services enhancements may include lower positioning latency, on-demand PRS, and/or GNSS support, etc. The use of carrier phase positioning may improve the accuracy.

### SUMMARY

A wireless transmit receive unit (WTRU) may receive configuration information. The configuration information may indicate one or more parameters for a first type of positioning reference signals (PRSs); one or more parameters for a second type of PRSs; and/or a number of consecutive symbols configured for velocity measurements associated with the first type of PRSs. The WTRU may perform positioning measurements for each of the first type of PRSs and the second type of PRSs. The WTRU may determine an estimated velocity associated with the WTRU based on a frequency modulated (FM) noise estimation associated with the first type of PRSs over the number of consecutive symbols indicated by the configuration information. The WTRU may send a feedback report comprising the positioning measurements for each of the first type of PRSs and second type of PRSs and an indication of the estimated velocity.

The WTRU may determine the estimated velocity by determining a power spectral density of an instantaneous frequency associated with the first type of PRSs over the number of consecutive symbols indicated by the configuration information; an determining an accumulated power over a plurality of subcarriers around a central subcarrier associated with the determined power spectral density, wherein the estimated velocity is determined based on the determined accumulated power.

The WTRU may apply measurements of the first type of PRSs for a positioning measurement under a non-line of sight (NLOS) condition using the determined estimated velocity determined based on the measurements of the first type of PRSs.

The WTRU may determine a relative velocity of the WTRU with respect to a transmit-receive point (TRP). The first type of PRSs may include a pseudo-random sequence of complex modulated symbols and the second type of PRSs comprise a legacy PRSs. The number of consecutive symbols of the first type of PRSs configured for velocity measurements may be mapped on one or more resource elements (REs) in an up-down and left-right configuration.

The positioning measurements may include one or more of a reference signal time difference (RSTD), a round-trip time (RTT), a reference signal received power per path (RSRPP), a reference signal carrier phase (RSCP), an angle of arrival (AoA), and/or a Doppler shift.

The first type of PRSs and/or the second type of PRSs may be sent by respective transmit nodes that are in LOS or NLOS conditions with the respect to the WTRU.

The estimated velocity may be determined by the WTRU being further configured to remove pre-existing complex symbols from the first type of PRSs over the number of consecutive symbols indicated by the configuration information; estimate an amount of FM noise associated with the first type of PRSs over the number of consecutive symbols after removal of the pre-existing complex symbols; and/or determine the power spectral density of the FM noise estimation using an absolute squared magnitude of a DFT of an instantaneous frequency associated with the first type of PRSs over the number of consecutive symbols.

The WTRU may determine an area estimate based on the positioning measurements for each of the second type of PRSs and send the area estimate via the feedback report.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example downlink (DL) Positioning Reference Signal (DL-PRS) for positioning a type 2 signal.

FIG. 3 depicts an example uplink (UL) Sounding Reference Signal (UL-SRS) for positioning a type 2 signal.

FIG. 4 depicts an example frequency multiplexing of DL-PRS type 2 signals corresponding to different transmit-receive points (TRPs) at a given DL-PRS type 2 occasion.

FIG. 5 depicts an example frequency multiplexing of SRS for positioning type 2 signals corresponding to different WTRUs at a given SRS for positioning (SRSp) type 2 occasion.

FIG. 6 depicts an example multiplexing of DL-PRS type 1 and type 2 signals.

FIG. 7 depicts an example multiplexing of UL-SRSp type 1 and type 2 signals.

FIG. 8 is a flowchart depicting an example reception of enhanced positioning signals.

FIG. 9 is a flowchart depicting an example for transmission of enhanced positioning signals.

FIG. 10 is a flowchart depicting an example interleaved transmission of enhanced positioning signals and/or legacy positioning signals.

FIG. 11 is a chart depicting an example FM noise power spectrum area as a function of velocity for Rayleigh flat channel and different SNR values, averaged after 5000 occasions.

FIG. 12 is a chart depicting an example FM noise power spectrum area as a function of velocity for 3GPP TDL-C (100 ns) channel and different SNR values, averaged after 5000 occasions.

FIG. 13 is a chart depicting an example FM noise power spectrum area as a function of velocity for 3GPP TDL-C (300 ns) channel and different SNR values, averaged after 5000 occasions.

FIG. 14 is a chart depicting an example FM noise power spectrum area as a function of velocity for 3GPP TDL-A (300 ns) channel and different SNR values, averaged after 5000 occasions.

FIG. 15 is a chart depicting an example FM noise power spectrum averaged after 1000 occasions for a Rayleigh flat channel at different velocities with SNR equal to 20 dB.

### DETAILED DESCRIPTION

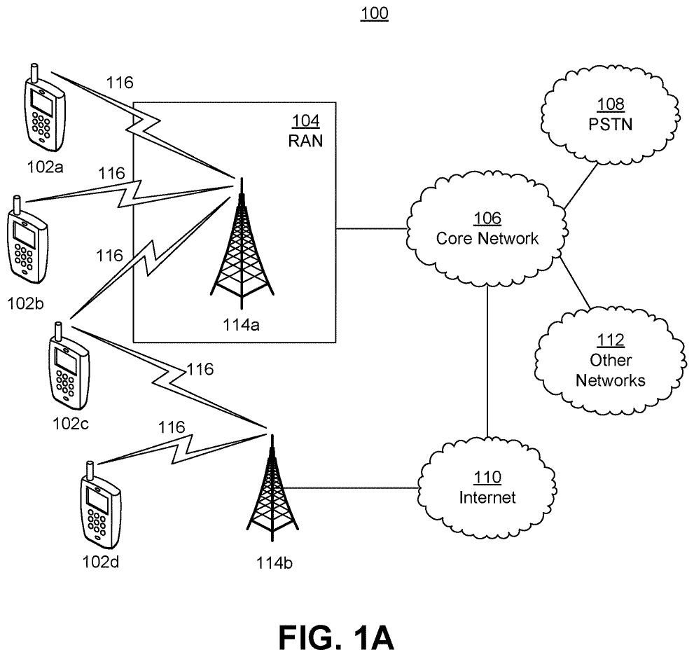

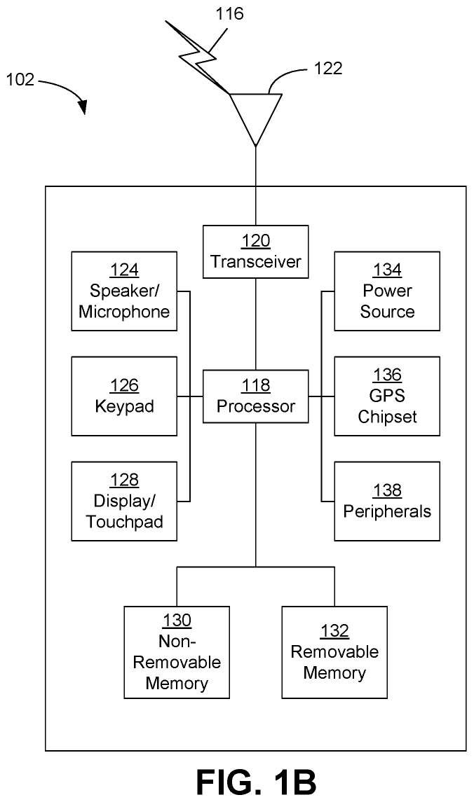

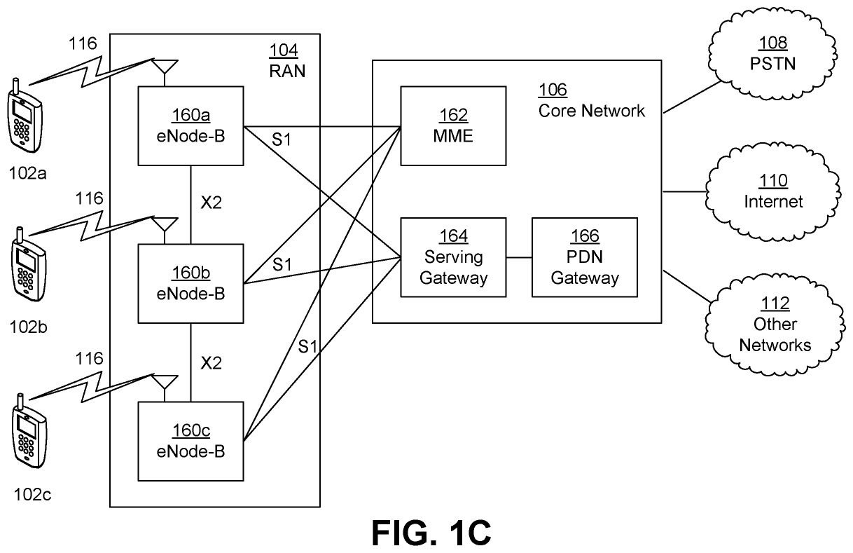

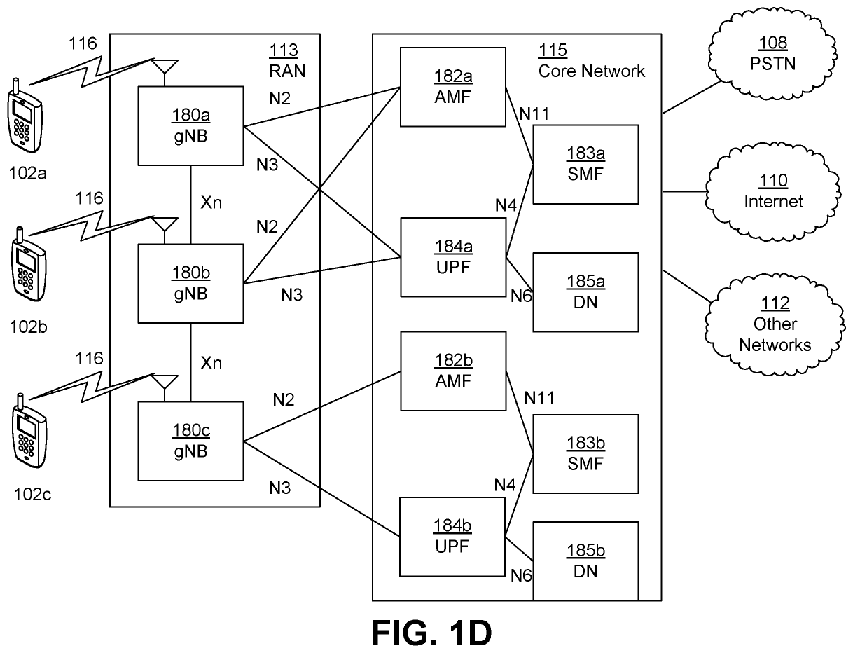

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., d support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Positioning methods and/or procedures in the field of wireless communications may be provided herein. One or more enhanced positioning signals may be aimed at efficiently positioning a moving device.

In addition to serving traffic towards/from WTRUs, providing accurate and/or robust positioning is becoming increasingly important in many applications. global navigation satellite systems (GNSS) may provide centimeter (cm)-level accuracy outdoors. However, many GNSS may suffer from multipath in urban environments as well as poor signal-to-noise (SNR) ratio in the already polluted industrial, scientific, and medical (ISM) bands. Moreover, GNSS procedures may require good outdoors visibility to more than one satellite and/or do not work indoors. In contrast, cellular-based positioning may benefit from the better quality and access conditions of the licensed bands while exploiting the already deployed mobile communications infrastructure.

Downlink (DL) positioning reference signals (DL PRS) and uplink (UL) sounding reference signals for positioning (UL SRSp) may enable a positioning accuracy of less than 3 meters (m) indoor and less than 10 m outdoor in general commercial use cases. Higher accuracy requirements may be required with less than 1 m for commercial use cases and less than 0.2 m for Industrial Internet of Things (IIoT) use cases. Other positioning services enhancements may include lower positioning latency, on-demand PRS, and/or GNSS support, etc. The use of carrier phase positioning may improve the accuracy.

The DL PRS signal may be a one-port signal spanning up to 272 resource blocks (RBs) in frequency and/or up to 12 OFDM symbols per slot in time, with a comb, frequency-staggered arrangement. This arrangement may allow for signal multiplexing from multiple TRPs without collisions. DL PRS resources may be grouped into PRS resource sets. PRS resources belonging to one PRS resource set may employ a different spatial filter for beamforming. PRS resource sets may be time-multiplexed across different symbols or slots (e.g., to allow for different spatial filters in beamformed PRS). PRS may be quasi co-located (QCL)-type D with other DL reference signals. The receive spatial filter employed to detect PRS may be assumed to be equal to that of the DL reference signal. PRS resource sets may be repeated for improved coverage, thereby allowing a measurement gap period to be defined between repetitions, and/or muted to avoid interferences to/from other cells. PRS signals may also be aperiodic with no measurement gap, to reduce latency. PRS signals may be initiated by WTRUs in an on-demand fashion.

UL SRSp may be one-port signals spanning up to 14 consecutive orthogonal frequency division multiplexing (OFDM) symbols in a slot and/or up to full bandwidth in a frequency-staggered fashion. This arrangement may allow for signal multiplexing from multiple users without collisions. The UL SRS signals may share many of the properties of the DL PRS signals.

PRS and/or SRSp signals may employ sequences with good auto-correlation properties so that a receiver can easily obtain the relative timing information through correlations with cyclically shifted sequence replicas. In examples, observed time difference of arrival (OTDoA) positioning techniques may employ (new radio) NR DL PRS signals for positioning. In other examples, uplink time difference of arrival (UTDoA) techniques may employ NR UL SRS signals for positioning. Receivers in both cases may extract the relative timing between the PRS and/or SRS signals corresponding to different TRPs. TRPs may be time-synchronized to follow a common time reference and ease the task of deriving positioning. In some cases, TRPs may also be non-synchronized.

Positioning techniques may be impaired by the presence of non-line of sight (NLOS) conditions. Consequently, in some systems, an information element (IE) LOS-NLOS-Indicator may be sent to inform about the likelihood of a TRP being in NLOS conditions. With this information, the system may exclude the TRP in NLOS conditions from the timing computations to avoid extra positioning errors. The LOS-NLOS IE may be sent based on the outcome of algorithms aimed at detecting the absence of a line of sight (LOS) component in a particular TRP.

Positioning and velocity estimation in non-line of sight (NLOS) may be enabled using one or more enhanced positioning signals. Cellular-based OTDoA and/or UTDoA positioning techniques may be based on positioning reference signals whose bandwidth is inversely proportional to the required positioning accuracy.

Despite the relatively high bandwidth of NR positioning signals, NR positioning signals may suffer from significant inaccuracies in NLOS scenarios. These significant inaccuracies may occur because of timing errors introduced by the multipath components. This situation may often be encountered in cellular urban channels. One or more procedures may include detecting the likelihood of NLOS to further exclude those measurements when appropriate. However, the measurements may be imprecise. The imprecise measurements may pose significant resources consumption from the unused positioning resource elements (REs). To compensate for this resource consumption, the system may involve additional TRPs to maximize the likelihood of being in LOS for at least three of them, but this may lead again to very high resource consumption.

No velocity information may be obtained from current NR positioning signals apart from the rate of change in the position, which is highly inaccurate in NLOS. Other existing procedures for velocity estimation may include, e.g., calculation of a Doppler shift. These types of calculations may not be valid in NLOS given the appearance of multiple Doppler shift components within the Doppler power spectrum. Long autocorrelations may be calculated to yield the Doppler spectrum. However, long autocorrections may require storing long sequences of complex received samples at the receiver for subsequent post-processing and are therefore highly complex.

Enhanced positioning signals may provide positioning and/or velocity estimation in either LOS or NLOS conditions. Standalone transmission of enhanced positioning signals may be provided.

A first WTRU or a set of first WTRUs may transmit signals to a second WTRU or a set of second WTRUs. The first WTRU or set of first WTRUs may transmit one or more signals to obtain configuration information on the parameters of one or more second positioning signals. The WTRU or set of first WTRUs may transmit one or more signals to obtain capabilities information on the one or more second positioning signals supported by the second WTRU or set of second WTRUs for enhanced positioning. The WTRU or set of first WTRUs may transmit one or more signals to obtain measurements and/or reports on user velocities and/or the channel state information (CSI).

The first WTRU or set of first WTRUs may construct a second positioning signal; map the second positioning signal to one or more symbols and/or one or more subcarriers; send positioning-related control signaling information; transmit the symbols.

The parameters of the second positioning signal may include a pseudo-random sequence type, a number of resource blocks (RBs), a number of symbols, a starting symbol, a number of slots between consecutive transmissions, and/or scheduling information.

The pseudo-random sequence type may be among a set of sequence types sharing the property that the autocorrelation of the sequences is zero, and/or below a threshold, for any non-null cyclic shift. The cross-correlation between sequences may be below a threshold.

The configuration information may be set by one or more higher-layer messages, e.g., such as radio resource control (RRC) configuration information, uplink control information/downlink control information (UCI/DCI) signaling, and/or medium access control-control element (MAC CE) commands. The configuration information may be pre-defined by the implementation.

The capabilities information may include a support of a second positioning signal, and/or any restrictions (e.g., the maximum number of RBs and/or symbols). The capabilities information may be sent by the second WTRU and/or a set of second WTRUs via higher-layer signaling during initial connection establishment. Additionally or alternatively, the capabilities information may be sent via an uplink shared control and/or data channel, and/or a MAC CE command.

The second positioning signal may be constructed such that the occupied bandwidth of the second positioning signal is equal to or less than the channel's coherence bandwidth;

The second positioning signal may be mapped to subcarriers in up-down and/or left-right fashion over the scheduled resource blocks and symbols.

The second positioning signal may be mapped to subcarriers such that signals transmitted by different sets of first WTRUs occupy different sets of subcarriers, (e.g., to avoid interference).

The number of symbols of the second positioning signal may be configured such that the velocity estimation resolution is a pre-defined value set by the implementation. The positioning signal-related control signaling information may comprise an indication of the presence of the positioning signal, the number of resource blocks, the number of symbols, the starting symbol, the number of slots between consecutive transmissions, and/or the scheduling information. The channel state information (CSI) may include frequency-domain signal quality information, for example, to derive the channel's coherence bandwidth.

The first WTRU may be a base station and/or base station equipment. The second WTRU or set of second WTRUs may be user equipment in the downlink of a wireless communication system. The set of first WTRUs may be multiple TRPs in the downlink of a multi-TRP wireless communication system. Additionally or alternatively, the first WTRU may be user equipment (UE). The second WTRU may be another UE in the sidelink or uplink of a wireless communication system. Additionally or alternatively, the first WTRU may be user equipment. The second WTRU may be base station equipment in the uplink of a wireless communication system. The set of second WTRUs may be multiple TRPs in the uplink of a multi-TRP wireless communication system.

Enhanced positioning signals and/or legacy positioning signals may be sent via interleaved transmission. A first WTRU or set of first WTRUs may transmit one or more signals to a second WTRU or set of second WTRUs. The first WTRU or set of first WTRUs may obtain configuration information on the parameters of a first and/or a second positioning signal and/or setting timer Q equal to an initial timer value Qinit. The first WTRU or set of first WTRUs may obtain capabilities information on the first and second positioning signals supported by the second WTRU or set of second WTRUs for enhanced positioning. The first WTRU or set of first WTRUs may obtain measurements and/or reports on user velocities and the channel state information, updating the initial timer value Qinit. The first WTRU or set of first WTRUs may construct a first and/or a second positioning signal based on the timer Q above zero and/or the user being in NLOS conditions. The first WTRU or set of first WTRUs may map the first or the second positioning signal to one or more symbols and/or one or more subcarriers. The first WTRU or set of first WTRUs may send positioning-related control signaling information. The first WTRU or set of first WTRUs may transmit the symbols and/or update the timer Q.

The parameters of the first positioning signal may be the same as the downlink positioning reference signal (DL PRS) parameters and/or uplink sounding reference signal (UL SRS) for positioning parameters in NR.

The parameters of the second positioning signal may include a pseudo-random sequence type, a number of resource blocks, a number of symbols, a starting symbol, a number of slots between consecutive transmissions, and/or scheduling information.

The pseudo-random sequence type may be one among a set of sequence types sharing the property that the autocorrelation of the sequences is zero, or below a threshold (e.g., very small), for any non-null cyclic shift, and/or the cross-correlation between sequences is below a threshold (e.g., very small).

The initial timer value Qinit may represent the time that must elapse between consecutive transmissions of the first positioning signal. The initial value of timer Q may be updated based on measurements and/or feedback from the second WTRU and/or set of second WTRUs. The distance covered over that time period may be smaller than a desired amount set by the implementation.

The configuration information may be set using one or more higher-layer messages, e.g., RRC configuration information, UCI/DCI signaling, and/or MAC CE commands. The configuration information may be pre-defined by the implementation.

The CSI may include frequency-domain signal quality information, for example, to derive the channel's coherence bandwidth.

The first positioning signal may be constructed if the timer Q is equal to zero and the user is in LOS conditions (e.g., there is at least one line of sight component in the channel impulse response) and mapped as the legacy positioning signal in NR.

The second positioning signal may be constructed such that the occupied bandwidth of the second positioning signal may be equal to or less than the channel's coherence bandwidth. The second positioning signal may be mapped to subcarriers in up-down and left-right fashion over a number of resource blocks and/or symbols if the timer Q is non-zero and/or the user is in NLOS conditions.

The first and the second positioning signals may be mapped to subcarriers such that signals transmitted by different sets of first WTRUs occupy different sets of subcarriers, for example, to avoid interference.

The number of symbols of the second positioning signal may be configured such that the velocity estimation resolution may be equal to a pre-defined value.

The positioning signal-related control signaling information may comprise one or more of an indication of the presence of the positioning signal, the number of resource blocks, the number of symbols, the starting symbol, the number of slots between consecutive transmissions, and/or the scheduling information.

The timer Q may be updated by decreasing the timer by an amount equal to the time elapsed since the last transmission of a first positioning signal if Q is different than zero, and/or set to the initial timer value Qinit if Q equals zero.

The first WTRU may be a base station equipment and the second WTRU and/or set of second WTRUs may be user equipment in the downlink of a wireless communication system.

The set of first WTRUs may comprise a plurality of TRPs in the downlink or an uplink of a multi-TRP wireless communication system. Additionally or alternatively, the first WTRU may be a UE. The second WTRU may be another UE in the sidelink of a wireless communication system. The set of second WTRUs may comprise a plurality of TRPs in the uplink of a multi-TRP wireless communication system.

DL PRS refers to the downlink positioning reference signal, and UL SRSp refers to the uplink sounding reference signal for positioning. Type 1 and type 2 alternatives of both signals are proposed and described herein to better cope with LOS and/or NLOS situations.

Communication may be established between one or multiple devices, (e.g., UEs (also known as WTRUs), and/or one or multiple base stations (BSs)). The BSs may provide means for connection to the network. In examples, the term TRP may be used instead of BS, particularly in multi-TRP scenarios where more than one TRP may collaborate in the transmission and/or reception of signals to and/or from users.

A cellular scenario may be considered when a network comprising several TRPs establishes wireless connections with one or multiple moving WTRUs. WTRU mobility may impact several radio resource management (RRM) procedures aimed at sustaining the link quality, e.g. beam management and/or handover. The links between the TRPs and the one or multiple WTRUs may exhibit LOS and/or NLOS conditions.

Examples and/or solutions described herein may be applicable, without loss of generality, to any signal waveform allowing frequency-domain analysis by means of discrete Fourier transforms (DFTs). For simplicity, an OFDM-like waveform, like cyclic prefix orthogonal frequency division multiplexing (CP-OFDM) and/or discrete Fourier transform spread orthogonal frequency division multiplexing (DFT-s-OFDM), will be used in the descriptions with N discrete samples in the time and/or frequency domain.

In sensing applications, two parameters of importance may include the root mean square (RMS) error and/or the resolution of the positioning technique. Assuming LOS conditions, techniques employing legacy DL PRS and/or UL sounding reference signal for positioning (SRSp) exhibit a mean squared positioning error

$${ε}_{rms , LOS}^{2}$$

in LOS conditions lower bounded by the Cramer-Rao Bound set for in Equation (1):

$${ε}_{rms , LOS}^{2} \geq \frac{{c}^{2}}{{B}_{rms}^{2} SNR} , \qquad ( 1 )$$

where c is the speed of light, SNR is the signal-to-noise ratio, and Bᵣₘₛ is the RMS bandwidth of the positioning signal expressed in Equation (2):

$${B}_{r m s}^{2} = \frac{{\int }_{- ∞}^{∞} {( 2 π f )}^{2} {\vert S ( f ) \vert}^{2} df}{{\int }_{- ∞}^{∞} {\vert S ( f ) \vert}^{2} df} . \qquad ( 2 )$$

From Equation (1), the higher the bandwidth of the positioning signal, the lower the positioning error. The positioning resolution Δε is given by Equation (3):

$$Δ ε = \pm \frac{c}{2 M Δ f} , \qquad ( 3 )$$

where Δf is the subcarrier spacing in an OFDM-like multicarrier symbol, and M is the number of subcarriers in the signal.

The timing information may be impaired by the multipath propagation in non-line-of-sight (NLOS) scenarios. If there no dominant line-of-sight signal component with highest received power exists, then stronger echoes with higher delays than the LOS component may corrupt timing measurements.

The additional positioning error,

$$Δ {ε}_{rms , NLOS}^{2} ,$$

may be related to the extra propagation time in the presence of multipath, Δtₚᵣₒₚ, and/or the timing uncertainty introduced by the channel's delay spread, τᵣₘₛ. Equation (4) may be derived under the reasonable assumption that Δtₚᵣₒₚ and t are independent random variables:

$$Δ {ε}_{rms , NLOS}^{2} ≅ {c}^{2} 𝔼 \{ {( Δ {t}_{prop} + τ )}^{2} \} = {c}^{2} [ 𝔼 \{ {( Δ {t}_{prop} )}^{2} \} + {τ}_{rms}^{2} + 2 𝔼 \{ Δ {t}_{prop} τ \} ] = {c}^{2} {\overline{Δ t}}_{prop}^{2} + \frac{{c}^{2}}{{B}_{c}^{2}} , \qquad ( 4 )$$

where

$${\overline{Δ t}}_{prop}^{2} {=}^{Δ} 𝔼 \{ {( Δ {t}_{prop} )}^{2} \}$$

is the mean squared value of the extra propagation time from multipath, and B_{c}=1/τᵣₘₛ is the channel's coherence bandwidth.

This additional positioning error

$$Δ {ε}_{rms , NLOS}^{2}$$

(e.g., as given by Equation (4)) incurred in the presence of multipath may be considered independent from the Cramer-Rao bound in Equation (1), so its mean squared values may be added. This addition may yield the overall mean squared error:

$${ε}_{rms , NLOS}^{2} \geq \frac{{c}^{2}}{{B}_{rms}^{2} SNR} + {c}^{2} {\overline{Δ t}}_{prop}^{2} + \frac{{c}^{2}}{{B}_{c}^{2}} . \qquad ( 5 )$$

In sensing applications and/or in communication scenarios that use radio resource management techniques based on mobility, estimation of the device's velocity may be required. A velocity v may lead to the appearance of Doppler impairments in the received signal. In NLOS scenarios, Doppler impairments may exhibit a spread of the signal's spectrum in the frequency domain. The maximum Doppler frequency f_{D}, may determine the frequency domain as given in Equation (6):

$${f}_{D} = {f}_{c} \frac{v}{c} , \qquad ( 6 )$$

where f_{c} is the carrier frequency and c is the speed of light.

Doppler spread may be the result of the convolution in frequency between the received signal spectrum and the Doppler spectrum of the channel. In NLOS Rayleigh channels, Doppler spread may not be estimated by standard techniques based on Doppler shift measurements. Rather, signals exhibit a superposition of Doppler shifts when the direct path may be obstructed, thus rendering such measurements useless.

Rather than a well-defined Doppler shift, Rayleigh NLOS channels may exhibit random phase variations caused by the user's mobility. After removing any a-priori known signal components from a baseband received signal r[n], the remaining instantaneous phase θ[n] and/or instantaneous frequency \dot{θ}[n] caused by the channel may be obtained according to Equations (7) and (8):

$$θ [ n ] = arg r [ n ] , \qquad ( 7 )$$

$$\dot{θ} [ n ] = \frac{1}{2 π} ( θ [ n ] - θ [ n - 1 ] ) , \qquad ( 8 )$$

Equation (8) may be commonly known as random FM noise. FM noise may be a characteristic effect of Doppler impairments. In Rayleigh NLOS flat channels, random FM noise may have a spectrum whose cutoff frequency proportional to the maximum Doppler frequency of the channel. Therefore, by measuring the random FM noise spectrum it may be possible to perform estimation of the user's velocity in NLOS conditions.

The instantaneous frequency in Equation (8) may require measurements performed over an apriori known positioning signal at consecutive discrete-time samples. Therefore, enhanced positioning signals may comprise a block structure in the frequency domain to enable velocity estimation as opposed to positioning signals based on comb shapes.

Moreover, spectrum estimation techniques may yield better frequency resolution with increased number of time-domain samples. Therefore, enhanced positioning signals may comprise multiple consecutive symbols for improved velocity resolution. These principles may be exploited in the definition of the enhanced positioning signals explained below.

The benefits of the enhanced positioning signals may include the ability to provide velocity estimation and coarse positioning in NLOS scenarios with the type 2 alternative, while ensuring standard high-accuracy positioning with the type 1. Both types may be multiplexed over time following an interleaving pattern. The interleaving pattern may be tailored to the user's mobility and/or the LOS/NLOS likelihood of the links to different TRPs. The estimated velocity may include a relative velocity determination of the WTRU with respect to a TRP. The WTRU may apply measurements of type 1 PRSs for a positioning measurement under a NLOS condition using the determined estimated velocity determined based on the measurements of type 1 PRSs.

Positioning reference signals may be enhanced with the introduction of type 2 signals to cope with the eventual presence of NLOS conditions. In examples, enhanced UL/DL positioning signals may be proposed comprising two signal types. Type 1 may correspond to the current UL SRSp/DL PRS signal. Type 1 signals may be aimed at positioning a WTRU by receiving positioning signals by and/or from at least three TRPs in LOS conditions. Type 2 may correspond to an alternative positioning signal aimed at WTRU positioning and/or velocity estimation in NLOS conditions. UL SRSp/DL PRS type 1 and type 2 may be complementary. UL SRSp/DL PRS type 1 and/or type 2 may interleave over time according to the velocity, likelihood of being in LOS/NLOS conditions, and/or resources overhead.

US SRSp/DL PRS type 1 may correspond to the legacy UL SRSp/DL PRS signal defined in NR Release 16 and Release 17. US SRSp/DL PRS type 1 may intend for accurate UL/DL positioning, with an accuracy of m or cm depending on the bandwidth and/or the carrier frequency, mostly applicable to LOS scenarios. UL SRSp/DL PRS type 1 may have the same signal definition and RE mapping as the legacy UL SRSp/DL PRS signal in NR. Hereinafter, the term “UL SRSp/DL PRS type 1” may be used interchangeably with the term “legacy UL SRSp/DL PRS.” The term “UL SRSp/DL PRS” may aim to differentiate from the alternative term UL SRSp/DL PRS type 2 signal, described herein.

UL SRSp/DL PRS type 2 may be an alternative positioning signal aimed for coarse positioning and velocity estimation in LOS and/or NLOS scenarios. Time and/or frequency parameters that describe UL SRSp/DL PRS type 2 signal may control the accuracy in positioning and/or velocity estimation attained by UL SRSp/DL PRS type 2 signal.

Both type 1 and type 2 signals may coexist. The UL SRSp/DL PRS type 2 signal may comprise any pseudo-random sequence of complex modulated symbols possessing good auto-correlation properties. The absolute value of the correlation between the sequence and/or any cyclically shifted version of the sequence may be very small, and/or the cross-correlation between sequences may be very small. Examples of such sequences include, e.g., the m-sequences, pseudo-noise (PN) sequences, and/or Zadoff-Chu sequences, etc.

The user may allocate some time-frequency resources, and/or reserve a set of UL SRSp/DL PRS type 2 resources. The resources may be reserved either to the WTRU and/or (in the DL case) to a set of WTRUs, for positioning.

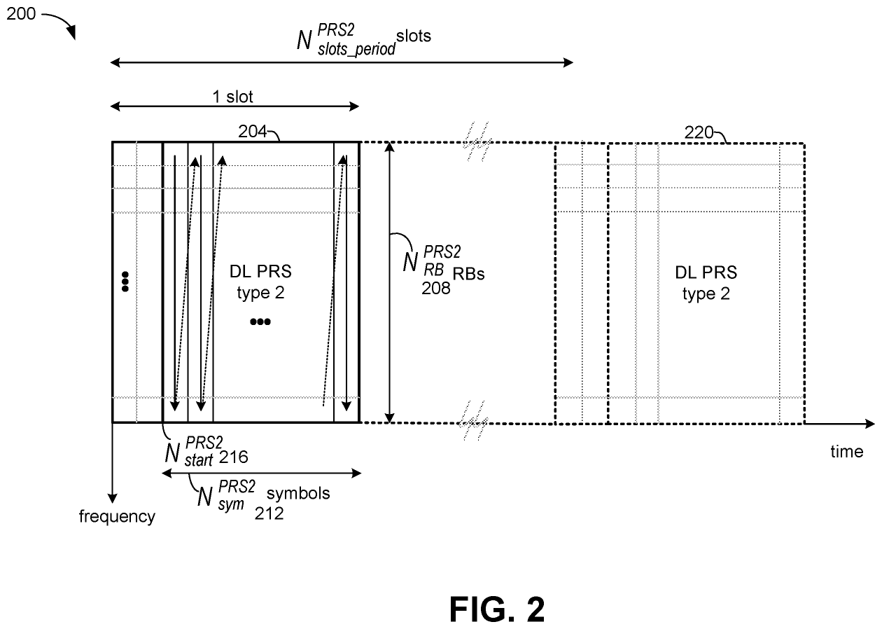

FIG. 2 depicts an example downlink (DL) Positioning Reference Signal (DL-PRS) type 2 signal. Specifically, FIG. 2 depicts the mapping 200 of complex modulated symbols to REs in a PRS type 2 occasion for DL. The DL PRS type 2 signal 204 may span one or more RBs 208, as denoted by

$${N}_{RB}^{PRS 2} ,$$

and/or several OFDM symbols 212 in a slot, as denoted by

$${N}_{sym}^{PRS 2} ,$$

starting from the symbol 216 given by

$${N}_{start}^{PRS 2} .$$

The DL PRS type 2 occasions may be repeated with a periodicity 220 given by

$${N}_{slots\_period}^{PRS 2} . ,$$

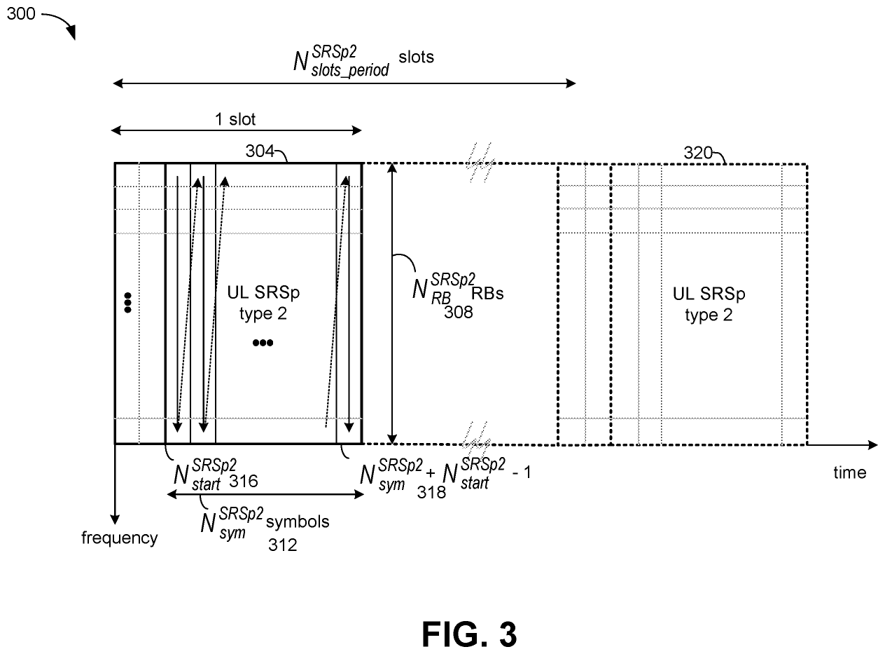

FIG. 3 depicts an example uplink (UL) Sounding Reference Signal (UL-SRS) type 2 signal. Specifically, FIG. 3 depicts the mapping 300 of complex modulated symbols to REs in a PRS type 2 occasion for UL. The UL SRSp type 2 signal 304 may span one or more RBs 308 as denoted by

$${N}_{RB}^{SRSp 2} .$$

The UL SRSp type 2 signals 304 may be mapped in up-down direction starting from symbol 316 given by

$${N}_{start}^{SRSp 2}$$

up to symbol 318 given by

$${N}_{start}^{SRSp 2} + {N}_{sym}^{SRSp 2} - 1$$

(e.g., the last symbol in slot 340). The UL SRSp type 2 occasions may be repeated with a periodicity 320 given by

$${N}_{slots\_period}^{SRSp 2} .$$

The structure of the UL SRSp and/or DL PRS type 2 signal may follow several design principles. The number of RBs may control the relative accuracy of the positioning and velocity estimation that can be obtained. Decreasing the number of RBs may reduce the positioning accuracy as per Equation (1). However, decreasing the number of RBs may increase velocity accuracy, as explained below. The number of RBs should be equal or smaller than the channel's coherence bandwidth so that the Rayleigh channel may be considered flat over the signal's bandwidth. This may allow velocity estimation via measurements of the instantaneous frequency spectrum.

The number of symbols value may control the velocity resolution, i.e., the minimum resolvable velocity attained by type 2 signals. The higher the value, the lower the minimum resolvable velocity, as explained previously, at the cost of higher positioning overhead from the increased resource consumption.

The periodicity may control the number of type 2 signals transmitted per unit time. In some cases, a small period

$${N}_{slots\_period}^{PRS 2} or {N}_{slots\_period}^{SRSp 2}$$

may be required to track a fast user. Small periods may also be beneficial for increasing the accuracy of velocity estimation, as described below.

Resource mapping, or the mapping of complex modulated symbols to REs, may be done in up-down and left-right fashion starting from symbol

$${N}_{start}^{PRS 2} or {N}_{start}^{SRSp 2}$$

in the slot. Such mapping of complex modulated symbols may allow measurements of the instantaneous frequency over consecutive time-frequency resources for velocity estimation.

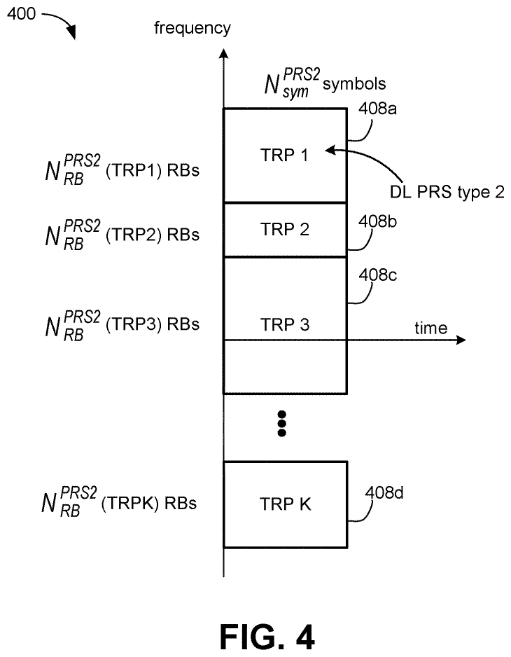

FIG. 4 depicts an example frequency multiplexing 400 of DL-PRS type 2 signals 408a, 408b, 408c, 408d corresponding to different TRPs at a given DL-PRS type 2 occasion. In the DL, as shown in FIG. 4, K TRPs may be allocated (e.g., simultaneously allocated) non-overlapping frequency resources in the same symbol, for example, to avoid collisions. FIG. 4 shows an equal number of OFDM symbols per PRS type 2 occasion at each TRP (e.g., TRP1, TRP2, TRP3, . . . TRPK), but different numbers of PRS symbols per TRP may exist. At least K=3 TRPs may be scheduled to enable positioning via trilateration (and/or multilateration) techniques. More TRPs may also be allocated to improve the positioning and velocity estimation accuracy, as described below.

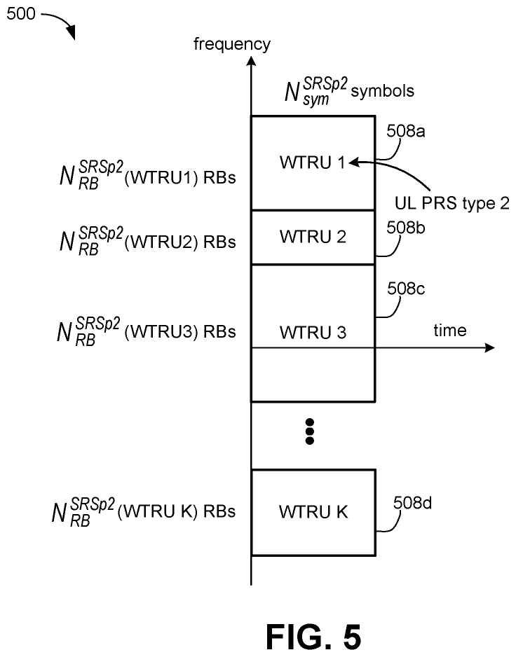

FIG. 5 depicts an example frequency multiplexing 500 of SRS for positioning type 2 signals 508a, 508b, 508c, 508d corresponding to different WTRUs at a given SRSp type 2 occasion. In the UL, as shown in FIG. 5, K WTRUs 504 may simultaneously allocate with non-overlapping frequency resources in the same symbol to avoid collisions. FIG. 5 shows an equal number of OFDM symbols per SRSp type 2 occasion corresponding to each WTRU (e.g., WTRU1, WTRU2, WTRU3, . . . WTRUK), but different numbers of SRSp symbols per WTRU may exist. At least K=3 TRPs should cooperate in detecting the SRSp signals to enable positioning via trilateration (and/or multilateration) techniques. More TRPs may also be allocated to improve the positioning and velocity estimation accuracy, as described below.

The DL PRS type 2 signals 408a, 408b, 408c, 408d transmitted by each TRP in one symbol may aim for positioning of a specific WTRU. The DL PRS type 2 signals 408a, 408b, 408c, 408d may therefore be allocated as part of their scheduled resources. Additionally or alternatively, given that DL PRS type 2 signals 408a, 408b, 408c, 408d do not include any WTRU-specific data, DL PRS type 2 signals 408a, 408b, 408c, 408d may be shared by multiple WTRUs for which positioning is activated, thus saving resources.

Control signalling and/or resources allocation for UL SRSp and/or DL PRS type 2 signals may reuse legacy 5G NR procedures (e.g., any DCI and/or MAC CE control signalling, and/or higher-layer system information messages).

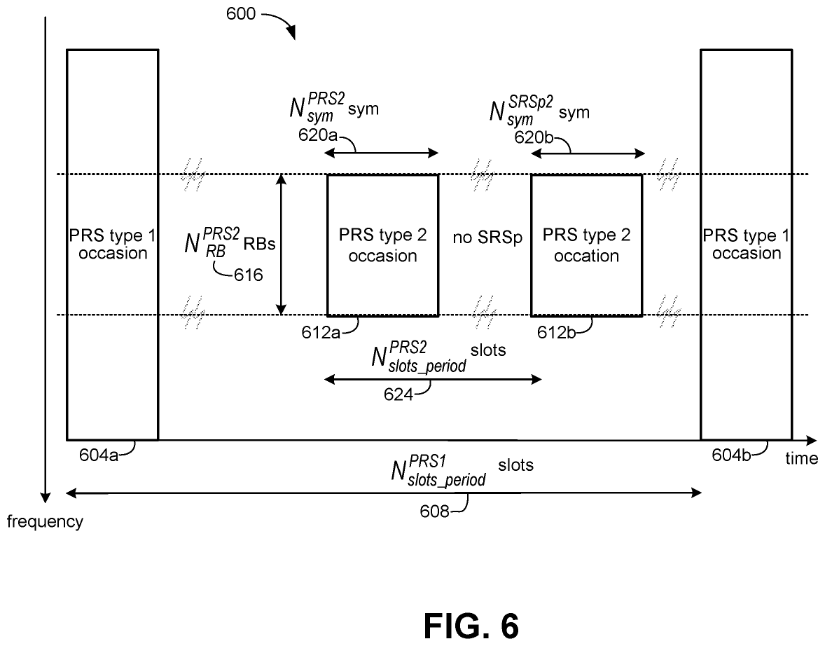

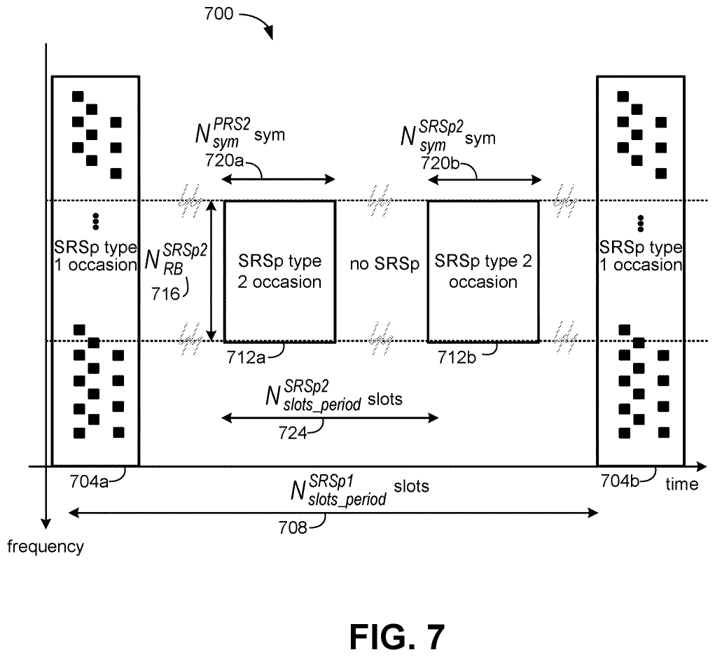

Enhanced type 1 and/or type 2 positioning signals may be multiplexed over time to adapt to the LOS/NLOS likelihood at the links with the TRPs. The network may multiplex different UL SRSp and/or DL PRS type 1 and/or type 2 occasions over time as shown in FIG. 6 and FIG. 7.

FIG. 6 depicts an example multiplexing 600 of DL-PRS type 1 and type 2 signals. PRS type 1 occasions 604a, 604b may comprise a set of legacy DL PRS resources. The legacy DL PRS resources may denote periodicity 608 as

$${N}_{slots\_period}^{PRS 1} .$$

PRS type 1 signals may span a large bandwidth and/or a configurable number of symbols in a slot and/or extend over one or multiple slots. One or several PRS type 2 occasions 612a, 612b may be transmitted between any two consecutive PRS type 1 occasions 604a, 604b, wherein PRS type 2 signals comprise

$${N}_{RB}^{PRS 2}$$

### RBs 616 and

$${N}_{sym}^{PRS 2}$$

symbols 620a, 620b with a periodicity of

$${N}_{slots\_period}^{PRS 2}$$

slots 624. The parameters

$${N}_{RB}^{PRS 2}$$

616,

$${N}_{sym}^{PRS 2}$$

620a, 620b, and

$${N}_{slots\_period}^{PRS 2}$$

624 may be changed dynamically according to channel and/or user conditions. In examples,

$${N}_{RB}^{PRS 2}$$

616 may be adapted to the channel conditions to ensure that

$${N}_{RB}^{PRS 2}$$

616 is always equal or smaller than the channel's coherence bandwidth.

$${N}_{sym}^{PRS 2}$$

620a, 620b may be selected according to the desired velocity resolution (e.g., the desired velocity resolution may depend on the estimated velocity, if desired). Periodicity

$${N}_{slots\_period}^{PRS 2}$$

624 may be adjusted to enable more frequent velocity estimations for highly-mobile users and vice versa.

In the DL example shown in FIG. 6, the bandwidth of PRS type 2 signals is smaller than the bandwidth of PRS type 1 signals and equal or smaller than the channel's coherence bandwidth. This may allow for accurate velocity estimation in NLOS conditions. There may be more PRS type 2 occasions per unit time than PRS type 1 occasions. This may allow for more frequent velocity estimation and/or coarse positioning when TRPs are in NLOS conditions while not incurring too much resource consumption due to its smaller bandwidth.

PRS type 1 occasions 604a, 604b may span higher bandwidth. PRS type 1 occasions 604a, 604b may be scheduled less often than PRS type 2 occasions 612a, 612b to enable accurate positioning by at least three TRPs in LOS conditions. However, PRS type 1 occasions 604a, 604b may not provide means for velocity estimation. By properly interleaving PRS type 1 occasions 604a, 604b and/or PRS type 2 occasions 612a, 612b over time, the system may enable positioning and/or velocity measurements according to the WTRU mobility and/or LOS/NLOS likelihood.

TRPs whose links to the WTRU have higher likelihood of being in LOS conditions may transmit PRS type 1 occasions, otherwise PRS type 2 signals may be transmitted. The rate of PRS type 1 occasions and/or type 2 occasions may be made dependent on the WTRU mobility such that highly-mobile users are more frequently tracked than slowly-moving users, and vice versa.

The rate of transmission of PRS type 2 occasions 612a, 612b may be made dependent on the signal to noise ratio (SNR) such that more signals are transmitted per unit time at low SNR conditions. Transmitting more signals per unit time at low SNR conditions may compensate for the lack of accuracy when measuring spectra as required for velocity estimation.

Semi-persistent transmission of DL PRS signals may also be possible. Semi-persistent transmission of DL PRS signals differ from periodic transmissions such that MAC CE commands may be used to activate and/or deactivate DL PRS transmissions in a dynamic way.

The system may trigger aperiodic DL PRS type 1 occasions 604a, 604b and/or type 2 occasions 612a, 612b. An aperiodic DL PRS type 1 occasion may trigger to update a WTRU location that may have changed over time. Aperiodic PRS type 2 occasions may also trigger to perform coarse positioning estimation, e.g., to update the WTRU location when there is significant likelihood of being in NLOS conditions, and/or to refine previous velocity measurements eventually performed at past instants.

The network and/or the WTRU may trigger periodic, semi-persistent, and/or aperiodic DL PRS occasions. When triggered by the WTRU, legacy procedures for on-demand transmission and reception of DL PRS signals in NR may be used for both PRS type 1 and/or type 2 signals. When triggered by the network, legacy procedures for regular transmission and/or reception of DL PRS signals in NR may also be used.

When multiple WTRUs share DL PRS type 2 signals, allocation of their resources may reuse control signaling mechanisms to indicate their time-frequency location and/or their eventual periodicity.

Examples described herein regarding the DL may apply to the UL by referring to the corresponding parameters on UL SRSp type 1 and/or type 2 signals as described in FIG. 7.

FIG. 7 depicts an example multiplexing of UL-SRSp type 1 and type 2 signals. SRSp type 1 occasions 704a-b may comprise a set of legacy UL SRS resources. These legacy UL SRS resources may denote periodicity 708 as

$${N}_{slots\_period}^{SRSp 1} .$$

SRSp type 1 signals may span a large bandwidth and/or a configurable number of symbols in a slot and/or extend over one or multiple slots. One or several SRSp type 2 occasions 712a, 712b may be transmitted between any two consecutive SRSp type 1 occasions 704a, 704b, wherein SRSp type 2 signals and

$${N}_{sym}^{SRSp 2}$$

symbols 720a, 720b with a periodicity of

$${N}_{slots\_period}^{SRSp2}$$

slots 724. The parameters

$${N}_{RB}^{SRSp 2}$$

716,

$${N}_{sym}^{SRSp 2}$$

720a, 720b, and

$${N}_{slots\_period}^{PRSp 2}$$

724 may be changed dynamically according to channel and/or user conditions.

$${N}_{sym}^{SRSp 2}$$

720a, 720b may be selected according to the desired velocity resolution (e.g., the desired velocity resolution may depend on the estimated velocity, if desired). Periodicity

$${N}_{slots\_period}^{SRSp 2}$$

724 may be adjusted to enable more frequent velocity estimations for highly-mobile users and vice versa.

The receiver (e.g., receiver WTRU) may perform one or more measurements on enhanced positioning signals to cope with LOS and/or NLOS conditions. The receiver may send these measurements in a report.

The receiver entity may send a request to the peer entity to get a positioning configuration. The peer entity may respond to the request by sending a configuration message comprising parameters of a type 1 positioning signal (e.g., number of RBs, comb size, and/or comb offset, etc.), a type 2 positioning signal (e.g., number of RBs, number of symbols, etc.), one or more measurements to perform (e.g., subcarriers to average in the random FM noise spectrum), and/or a reporting configuration.

In examples, the receiver entity may obtain the positioning configuration upon initial registration to the system, and/or at other times and by other means (e.g., via operation and/or maintenance, and/or service configuration, etc.).

The receiver entity may be configured and/or determined to perform positioning measurements on the one or more positioning signals of type 1 and/or type 2 received from one or more transmit nodes. The positioning measurements may include a reference signal time difference (RSTD), a round-trip time (RTT), a reference signal received power per path (RSRPP), a reference signal carrier phase (RSCP), an angle of arrival (AoA), and/or a Doppler shift. The positioning measurements may be performed on type 1 positioning signals and/or type 2 positioning signals sent by transmit nodes (e.g., transmitting WTRUs). These transmit nodes may have channel links with the receiver that may be in either LOS or NLOS conditions. For example, the type 1 positioning signals and/or the type 2 positioning signals may be sent by the transmit nodes that are in either LOS or NLOS conditions with respect to the receiver. In NLOS, positioning accuracy may be intrinsically limited by the extra propagation time and/or the channel's coherence bandwidth as described in Equation (5).

The receiver entity may perform additional measurements on the type 2 positioning signals received, for example, to obtain an estimate of the velocity magnitude. To obtain the estimate of the velocity magnitude, the receiver may first remove the pre-existing (e.g., apriori known) complex symbols from the baseband received signal over a configured number of symbols

$${N}_{sym}^{PRS 2} .$$

The receiver may estimate an amount of FM noise (e.g., random FM noise) characterizing the channel variations. The estimated amount of FM noise may be associated with the type 2 positioning signals over the number of consecutive symbols after removal of the pre-existing complex symbols. In examples, random FM noise may be obtained from the received symbols after removal of the type 2 positioning signals r[n] by means of an instantaneous frequency θ[n]=½π (θ[n]−θ[n−1]), where θ[n]=arg [symbol] r[n] [symbol] is an instantaneous phase and n is the sample within a symbol as seen in Equations 7 and 8.

The receiver entity may determine (e.g., compute) a power spectral density of the random FM noise, (e.g., via the absolute squared magnitude of a DFT of θ[n]), and/or accumulate the power over a configured and/or determined number of subcarriers around the central one. For example, the receiver may determine the power spectral density of the random FM noise using an absolute squared magnitude of a DFT of an instantaneous frequency associated with the type 1 positioning signals over the number of consecutive symbols.

The computed power may exhibit an apriori known relationship with velocity (e.g., a quadratic curve as in Rayleigh channels), that the receiver may exploit to derive the velocity estimate.

Area computations may be averaged over multiple positioning occasions (e.g., over multiple consecutive or non-consecutive slots comprising type 2 positioning signals), for example, to improve the estimation accuracy.

The receiver entity may compare the obtained area with a pre-stored table of areas for different velocities and/or SNRs to derive a velocity estimate (e.g., by means of a quadratic fit). In examples, the receiver may employ threshold extension techniques to mitigate the increased inaccuracies of phase measurements, for example, when SNR is close to the threshold SNR.

The receiver entity may subtract an area bias corresponding to phase slip errors at zero velocity from the random FM noise spectrum. This area bias may be pre-computed and/or stored for various values of the SNR, channel conditions, and/or positioning signal configurations, etc, for improved accuracy.

The receiver entity may be configured and/or determined to use the velocity estimations for positioning determination and/or measurement in NLOS conditions. In examples, the receiver entity may report the measurements and/or the velocity estimates.

The receiver may be configured and/or determined to report a velocity estimate from the measurements performed on the type 2 positioning signals, e.g., a value (in kilometers per hour (km/h), or meters per second (m/s)) derived from comparison with pre-stored area values versus velocity for different SNRs, channel conditions, and/or signal configurations, etc. The velocity estimate may be reported in an uplink or downlink control or data channel (e.g., physical uplink shared channel (PUSCH), physical uplink control channel (PUCCH), physical downlink shared channel (PDSCH), physical downlink control channel (PDCCH), etc.) as part of a positioning report and/or in a separate report.

In some cases, the receiver may be configured and/or determined to report the area estimate obtained from measurements of the received type 2 positioning signals, as part of a positioning report and/or in a separate report. The area estimate may be digitally encoded and/or compressed according to any suitable pre-defined format. An index to a table of pre-defined area values may be reported to minimize the resources consumption.

Reports may be sent in a periodic, aperiodic, and/or semi-persistent fashion to a transmitter entity (e.g., a TRP), or a network node (e.g., location management function (LMF)), according to a configuration.

DL PRS type 1 and/or UL SRSp type 1 signals may provide high positioning accuracy in LOS thanks to their high bandwidth. High positioning accuracy may yield low positioning error as per Equation (1).

However, in NLOS situations, two sources of impairments as shown in Equation (5) may impact the positioning accuracy. These two sources of impairments may include the extra propagation time incurred by reflections and/or other scattering phenomena, and/or the non-zero channel delay spread. Extra propagation time incurred by reflections and/or other scattering phenomena may not be controlled. However, extra propagation time usually may be less harmful than the non-zero channel delay spread. A non-zero delay spread may make the receiver erroneously estimate the timings if a strong NLOS component dominates over a weaker LOS component. Performance of type 1 signals may be significantly impacted by the RMS delay spread in NLOS conditions.

In contrast, if the bandwidth of type 2 signals is equal or smaller than the channel's coherence bandwidth, then no significant multipath may be visible over the signal's bandwidth. Moreover, performance may be dominated by the inverse of its bandwidth, which is equal to the RMS delay spread as in type 1 signals. Consequently, DL PRS type 2 and/or UL SRSp type 2 signals may provide the same positioning accuracy as type 1 signals in NLOS scenarios, albeit with may fewer resources and/or overhead.

Additionally or alternatively, type 2 signals my enable velocity estimation in NLOS if their bandwidth is equal or smaller than the channel's coherence bandwidth. This may occur by allowing the receiver to obtain statistics of the flat Rayleigh fading process thanks to its block structure.

Type 2 signal may be dynamically adapted to the channel's coherence bandwidth. CSI measurements or reports may aid adaptation of the type 2 signal bandwidth to the channel's coherence bandwidth. Given that the delay spread is reciprocal in UL and/or DL, the coherence bandwidth may be estimated on transmission by performing channel measurements on the reverse link.

Hereinafter, the term “type 1 signal” is denoted as a “first positioning signal”, and the term “type 2 signal” is a “second positioning signal”.

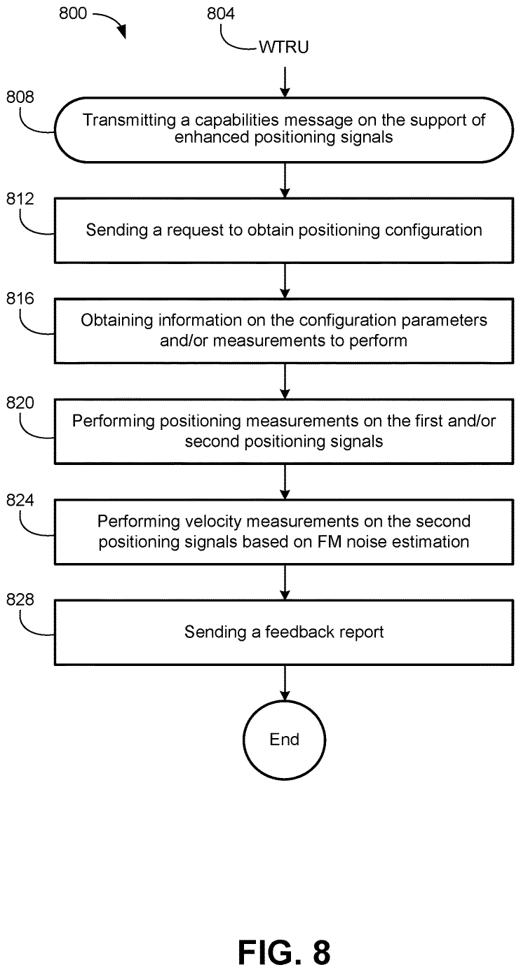

FIG. 8 is a flowchart 800 depicting an example reception of enhanced positioning signals. As shown in FIG. 8, a first WTRU 804 may be configured and/or determined to perform positioning measurements on one or more enhanced positioning signals received from a second WTRU or set of second WTRUs, in UL or DL, by means of the following steps:

At 808, the first WTRU 804 may transmit a capabilities message (e.g., during initial registration) comprising information associated with support of a first positioning signal and a second positioning signal; support of velocity estimation capabilities; a velocity resolution (e.g., minimum measurable velocity); a maximum estimated velocity; and/or a maximum number of symbols or subcarriers to measure, etc.

At 812, the first WTRU 804 may send a request to obtain positioning configuration, (e.g., upon initial access and/or registration to the system). At 816, the first WTRU 804 may obtain information on the configuration parameters and/or measurements to perform on a first and/or a second positioning signal (e.g., from a received configuration message, operation and/or maintenance, service configuration, etc.), comprising a pseudo-random sequence type; a number of RBs; a number of symbols; transmission periodicity (e.g., periodic, aperiodic, semi-persistent, and/or event-triggered, etc.), one or more positioning measurements for the first and/or the second positioning signal (e.g., RSTD, RTT, RSRPP, AoA, and/pr RSCP, etc.); one or more velocity measurements for the second positioning signal (e.g., number of subcarriers to aggregate the power spectral density of the random FM noise, and/or number of slots to average, etc.); a LOS/NLOS probability of the link (e.g., represented as a percentage, an integer from 0 to 100, or an index to a predefined table, etc.), a set of area values versus velocity, and/or an index to a pre-defined table (e.g., for different SNRs, channel conditions, and/or signal configurations, etc.) to use for velocity estimations.

At 820, the first WTRU 804 may perform one or more positioning measurements on the first positioning signals and/or the second positioning signals received from the second WTRU or set of second WTRUs. At 824, if the first WTRU 804 detects one or more transmissions of a second positioning signal, the first WTRU 804 may perform velocity measurements based on a frequency modulated (FM) noise estimation.

The first WTRU 804 may remove the apriori known complex symbols of the second positioning signal from the received signal over the configured number of symbols (e.g., by division with their apriori known complex values). The first WTRU 804 may obtain a random FM noise from the channel. In examples, random FM noise may be obtained by means of an instantaneous frequency signal θ[n]=½π (θ[n]−θ[n−1]) obtained from the received symbols r[n] after removal of the second positioning signal, wherein θ[n]=arg [symbol] r[n] [symbol] is an instantaneous phase and n is the sample within a symbol as seen in Equations 7 and 8.

The first WTRU 804 may compute the power spectral density of the random FM noise by, e.g., obtaining the absolute squared magnitude of a DFT over θ[n]. The first WTRU 804 may accumulate the power over a configured and/or determined number of subcarriers around the central subcarrier.

The first WTRU 804 may average out the area values over multiple positioning occasions (e.g., multiple consecutive or non-consecutive slots comprising a second positioning signal as provided in the configuration), for example, to improve the estimation accuracy. The first WTRU 804 may compare the obtained area with a set of area values (e.g., a pre-stored table of areas for different velocities as provided in the configuration), and/or using the comparison to derive a velocity estimate (e.g., via a quadratic fit). The first WTRU 804 may leverage an apriori known relationship with velocity (e.g., a quadratic curve as in Rayleigh channels) provided in the configuration and/or determined by the first WTRU 804 to derive the velocity estimate.

At 828, the first WTRU 804 may send a report (e.g., an enhanced positioning report) over a control or data channel. The report comprising one or more estimated WTRU coordinates (e.g., absolute or relative to a known coordinates reference system) and/or their uncertainties (e.g., as a confidence interval and/or a probability, etc.); one or more positioning measurements (e.g., RSTD, RTT, RSRPP, RSCP, and/pr AoA, etc.) and/or their uncertainties; one or more velocity measurements based on a FM noise estimation (e.g., the area of the power spectral density of the random FM noise over the configured subcarriers), in any digital format or as an index to a table of pre-defined values and/or their uncertainties; and/or a velocity estimate (e.g., in km/h, m/s, and/or an index to a table of values, etc.) and/or its uncertainty.

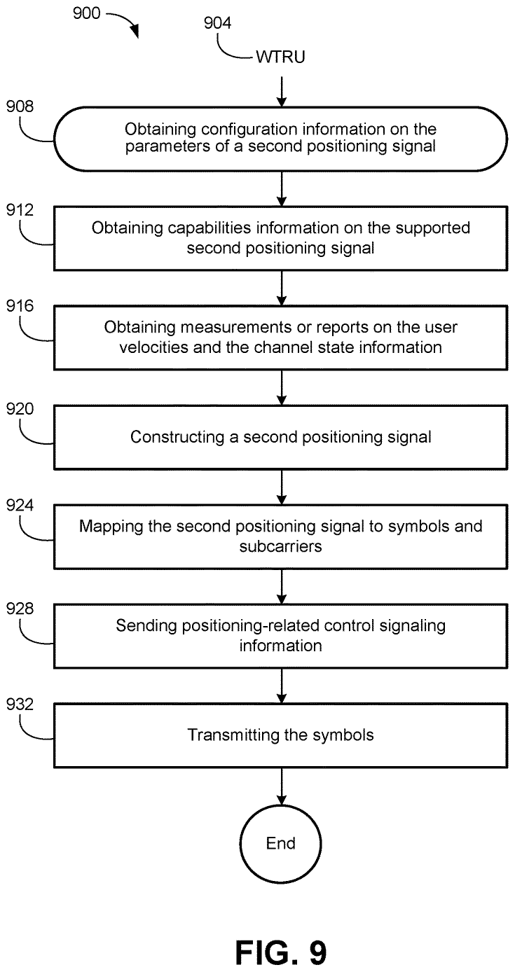

FIG. 9 is a flowchart depicting an example for transmission of enhanced positioning signals. As shown in FIG. 9, a first WTRU 904 and/or set of first WTRUs may be aimed to transmit a second positioning signal to a second WTRU and/or set of second WTRUs in UL and/or DL.

At 908, the transmitter (e.g., the first WTRU 904) may obtain (e.g., first obtain) configuration information on the parameters of a second positioning signal (e.g., the pseudo-random sequence type, number of RBs, number of symbols, and/or periodicity, etc.). At 912, the transmitter may then obtain additional capabilities information on the support of enhanced positioning signals at the receive side.

At 916, measurements performed by the transmitter and/or reports obtained from the receiver on a reverse link may obtain CSI. Given that the coherence bandwidth is reciprocal in UL and/or DL, the WTRU may perform measurements on the reverse link even in frequency-division duplex (FDD) systems. The WTRU may estimate the coherence bandwidth and/or obtain user velocities via these measurements and/or reports. Measurements may be performed at the transmitter side by exploiting the reciprocity of Doppler-related quantities in UL and/or DL.

Measurements may also be performed at the receiver side. Feedback to the transmitter by means of a velocity report may be sent over a reverse link. Such velocity report may include Doppler-related measurements (e.g., based on the random FM noise, and/or possibly including an estimation of the user velocity made by the receiver). The rate of velocity measurements and/or reports may be set by higher-layer signaling and/or triggered upon fulfilment of certain conditions (e.g., when the maximum relative variation of the CSI with respect to a past instant exceeds a pre-configured threshold). Reports may be sent on a periodic, semi-persistent, aperiodic, and/or on-demand fashion.

Signalling information on velocity measurements, velocity reports, and/or any triggering conditions may be obtained from, e.g., RRC configuration information, DCI signalling, and/or MAC CE commands.

At 920, when equipped with this information, the transmitter may construct a second positioning signal. At 924 the transmitter may map the second positioning signal to symbols and/or subcarriers according to the selected configuration. The higher layers may set a starting RB and/or starting symbol of the second positioning signal to avoid collisions with any other second positioning signals and/or data and/or control information. The bandwidth, measured in RBs, may be set to be equal or smaller than the channel's coherence bandwidth as required for velocity estimations.

The number of symbols of the second positioning signal may be set to achieve a given velocity resolution. The number of symbols, RBs, the starting symbol, and/or starting RB may be set between certain minimum and maximum values. Moreover, the number of symbols, RBs, the starting symbol, and/or starting RB may be picked among a set of possibilities configured by higher layers via RRC signaling, DCI information, and/or MAC CE commands.

At 928, the WTRU may send signaling information related to the parameters of the second positioning signal to enable detection at the receive side (e.g., in a RRC configuration message, UCI/DCI signaling information, and/or MAC CE command, etc.). Signaling may include, e.g., information on the pseudo-random sequence type (e.g., either explicitly and/or based on a pre-defined codebook of sequences), number of resource blocks, number of symbols, starting symbol, number of slots between consecutive transmissions, and/or any time-frequency scheduling information like the starting RB and/or slot for the second positioning signal. At 932, the WTRU may transmit symbols including the second positioning signal.

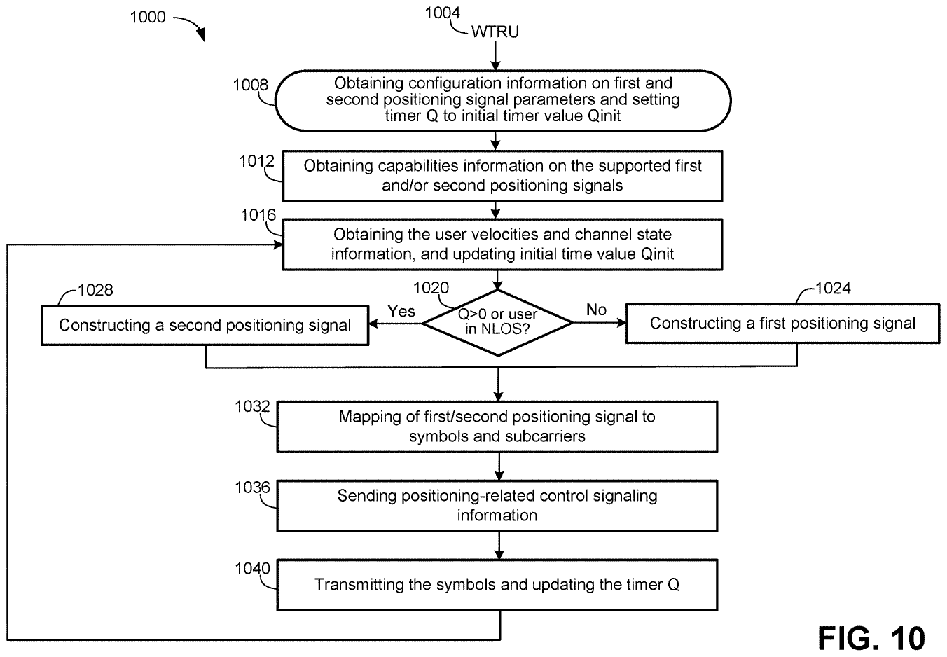

FIG. 10 is a flowchart depicting an example interleaved transmission of enhanced positioning signals and/or legacy positioning signals. As shown in FIG. 10, a first WTRU 1004 and/or set of first WTRUs may be aimed to transmit both first and/or second positioning signals to a second WTRU and/or set of second WTRUs in UL and/or DL.

At 1008, the transmitter (e.g., the first WTRU 1004) may first obtain configuration information on the parameters of a first and a second positioning signal (e.g., the pseudo-random sequence type, number of RBs, number of symbols, and/or periodicity, etc.).

The transmitter may also set a timer Q to an initial value Qinit. Timer Q may include the time that remains until the next scheduled transmission of a first positioning signal. Timer Q may be set such that the distance covered over that time period may be smaller than a desired positioning resolution set by the implementation. The units of Qinit may be expressed in, e.g., time (e.g., seconds, milliseconds, microseconds, etc.), number of symbols, number of slots, and/or any other suitable magnitude related to UL/DL timing. At 1012, the transmitter may obtain additional capabilities information on the support of a first and/or a second positioning signal at the receive side.

At 1016, measurements performed by the transmitter and/or reports obtained from the receiver on a reverse link may obtain CSI. Given that the coherence bandwidth is reciprocal in UL and DL, the WTRU may perform measurements on the reverse link even in FDD systems. The WTRU may obtain user velocities via these measurements and/or reports. Based on this information, the initial timer value Qinit may be updated accordingly to the velocities such that the distance covered by the user over the time period Qinit may be smaller than a desired amount set (e.g., set by the implementation). In this configuration, the next time the timer Q reaches zero, the timer Q may be re-initialized to the most up-to-date value according to the updated user velocity. Actual values may have a pre-defined granularity based on, e.g., signaling overhead constraints.

At 1020, the transmitter may construct a first and/or a second positioning signal depending on the timer Q and the likelihood of being in LOS/NLOS. The likelihood of being in LOS/NLOS, may be determined by the CSI and the CSI may map the positioning signal to symbols and/or subcarriers according to the selected configuration. At 1024, the WTRU may construct a first positioning signal is the timer Q is greater than a threshold or is not in NLOS. At 1028, the WTRU may construct a second positioning signal if the timer Q is less than a threshold.

The configuration information may include parameters describing a first positioning signal. Parameters describing a second positioning signal may be selected based on the configuration information, the user mobility, and/or channel conditions. At 1032, the transmitter may then map the first and/or second positioning signal(s) to symbols and/or subcarriers according to the selected configuration. The higher layers may set the starting RB and/or starting symbol of a second positioning signal to avoid collisions with any other second positioning signals and/or data and/or control information. The bandwidth, measured in RBs, may be set to be equal or smaller than the channel's coherence bandwidth as required for velocity estimations.

The number of symbols of the second positioning signal may be set such to achieve a given velocity resolution. The number of symbols, RBs, the starting symbol, and/or starting RB, may be set between certain minimum and maximum values. Moreover, the number of symbols, RBs, the starting symbol, and/or starting RB may be picked among a set of possibilities configured by higher layers via RRC signaling, DCI information, and/or MAC CE commands.

At 1036, the WTRU may send signaling information related to the positioning signal to enable detection at the receive side. At 1040, the WTRU may transmit symbols, including the positioning signal. The WTRU may update the timer Q to reflect the time remaining until the next transmission of a first positioning signal. This update may decrease Q by an amount equal to the time elapsed. This decrease may be based on the last transmission of a first positioning signal if Q is different than zero or set to the initial timer value Qinit if Q equals zero.

One or more numerical simulations may be presented herein to illustrate the velocity estimation capabilities of type 2 positioning signals under the assumptions listed in Table 1. In examples, The DL PRS type 2 signal (e.g., only the DL PRS type 2 signal) may be considered in the one or more numerical simulations described herein, for example, for simplicity. However, the conclusions may apply to UL SRSp type 2. The receiver may discard the contents of the PRS signal before obtaining the FM noise spectrum. PRS type 2 signals in the simulations may comprise three RBs and/or 15 symbols and/or may be ideally transmitted in every slot. Area calculations may be performed over the interval [DC−δ, DC+δ] after averaging over 5000 occasions. One or more realistic configurations may demand fewer slots because signals from several TRPs may be frequency-multiplexed to improve the estimation. A value of δ=7 was arbitrarily selected for calculations.

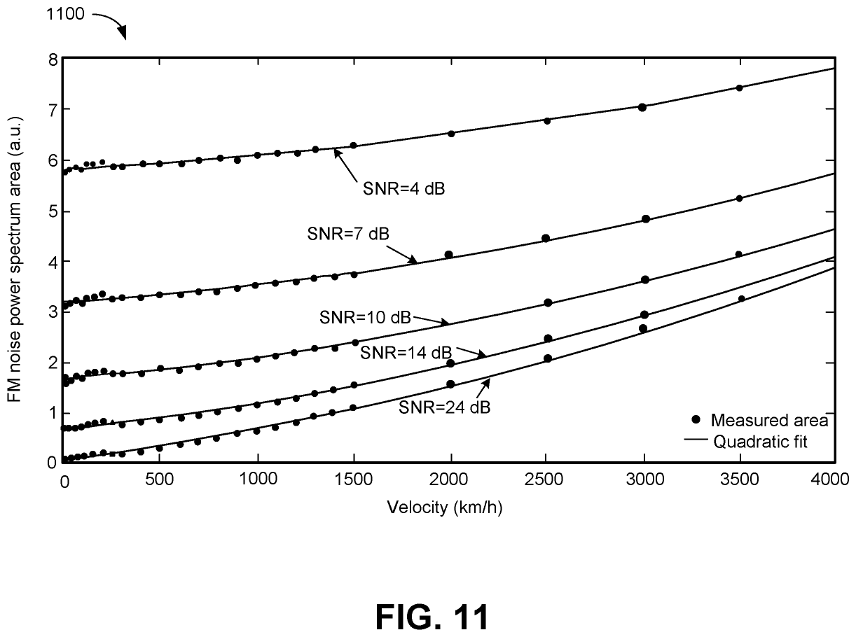

FIG. 11 depicts an example plot 1100 of FM noise power spectrum area as a function of velocity for Raleigh flat channel and different SNR values, averaged after 5000 occasions. As shown in FIG. 11, the area obtained as a function of velocity for a flat Rayleigh channel and different SNR values. For sufficiently high SNR and velocity, a quadratic fit may be accurate and the receiver may compare the numerical area against a pre-stored look-up table to estimate velocity. At low velocities, and for SNR values close to or below the threshold SNR (10 dB), numerical calculations may suffer from imprecision(s) that threshold extension techniques may alleviate. Moreover, the area bias that appears at zero velocity phase slips may cause a systematic error. The receiver may pre-calculate this error as a function of SNR and may subtract to improve accuracy.

TABLE 1
Simulation Assumptions

| Parameter | Value | Comments |
|---|---|---|
| Carrier frequency, f_{c} | 4 GHZ | |
| Subcarrier spacing, Δf | 15 kHz | |
| Enhanced positioning | DL PRS type 2 signal | For (e.g., only for) velocity |
| signal | | estimation |
| Number of DL PRS type | 3 RBs | Selected so that the signal |
| $2 RBs , {N}_{R B}^{P R S 2}$ | | bandwidth is smaller than the |
| | | channel's coherence |
| | | bandwidth |
| Number of DL PRS type | 15 | 15 symbols are ideally |
| $2 symbols , {N}_{s y m}^{P R S 2}$ | | processed to yield an |
| | | effective subcarrier spacing |
| | | of Δf/15 = 1 kHz |
| PRS type 2 periodicity | Once per slot | |
| Number of PRS type 2 | 1000 and 5000 | 1000 PRS type 2 occasions |
| occasions | | for the FM noise power |
| | | spectrum, and 5000 |
| | | occasions for area |
| | | calculations |
| Channel model | Rayleigh flat, TDL-C | NLOS channels with no |
| | 100 ns, TDL-C 300 ns, | Ricean component in all |
| | TDL-A 300 ns | cases |
| Value of δ for calculation | 7 subcarriers | Area is calculated over the |
| of the FM noise spectrum | | subcarriers [DC − δ, DC + δ] |
| Velocity | 3 km/h-4000 km/h | |
| SNR | 4 dB-30 dB | |
| Threshold SNR | 10 dB | |

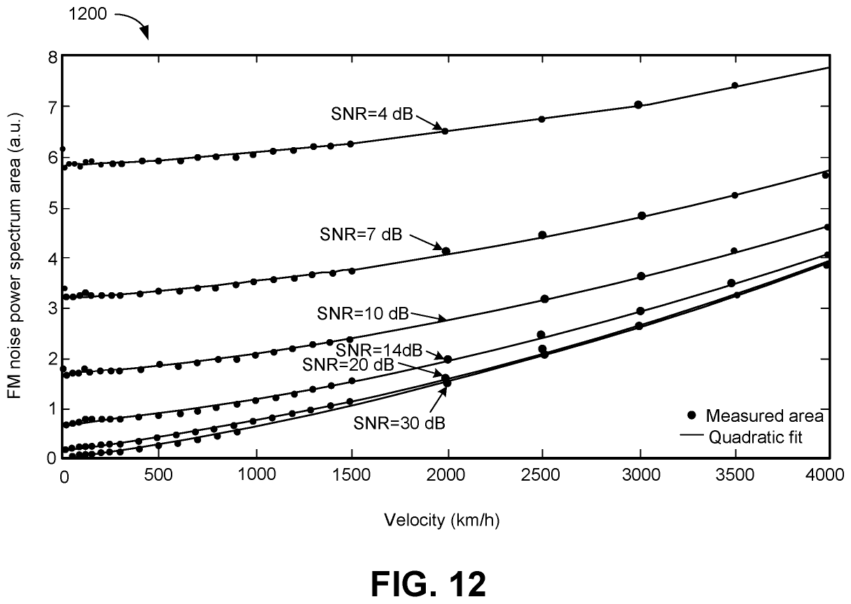

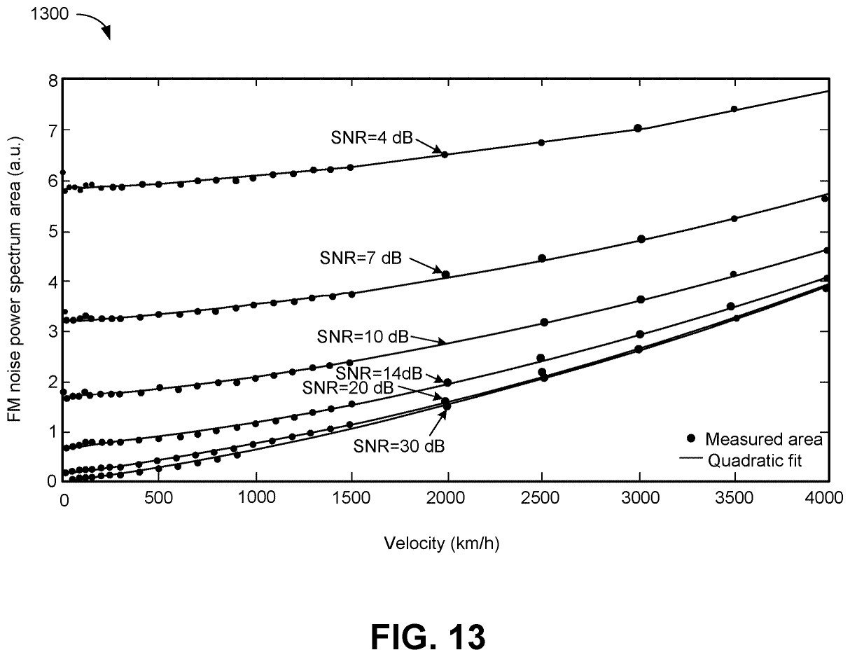

Velocity estimation may also be feasible in frequency-selective channels, for example, if the signal's bandwidth is equal or smaller than the channel's coherence bandwidth. FIG. 12 and/or FIG. 13 may illustrate the cases with 3GPP TDL-C 100 ns and 300 ns channel models respectively. FIG. 12 depicts an example plot 1200 of FM noise power spectrum area as a function of velocity for 3GPP TDL-C (100 ns) channel and different SNR values, averaged after 5000 occasions. FIG. 13 depicts an example plot 1300 of FM noise power spectrum area as a function of velocity for 3GPP TDL-C (300 ns) channel and different SNR values, averaged after 5000 occasions. These channel models' coherence bandwidths (10 MHz and 3.33 MHz, respectively) may be larger than the signal's bandwidth. Despite the different power delay profiles in FIG. 11, FIG. 12, and/or FIG. 13, a quadratic fit may yield almost identical results.

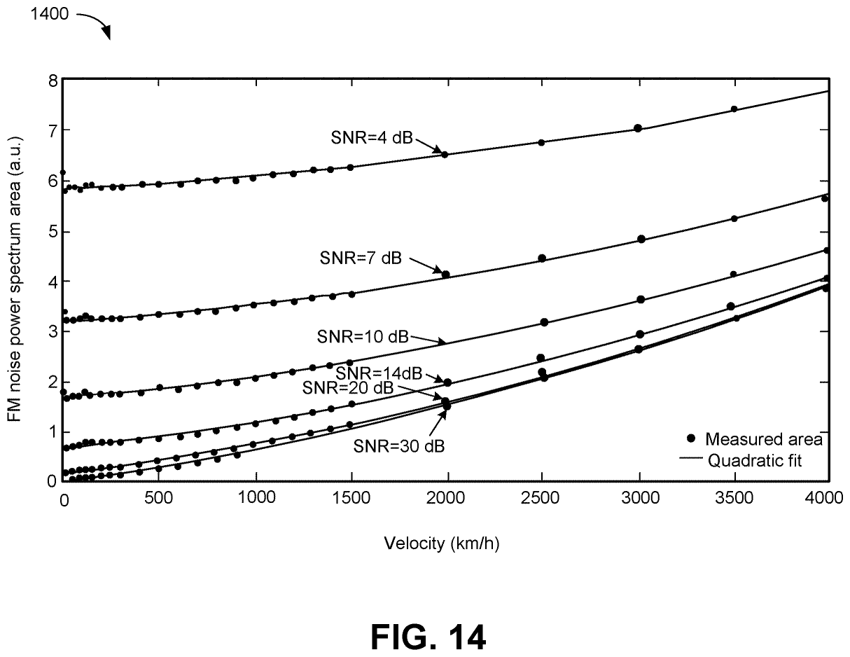

Results may not change significantly with the multipath profile of the channel as long as the coherence bandwidth remains constant. FIG. 14 depicts an example plot 1400 of FM noise power spectrum area as a function of velocity for 3GPP TDL-A (300 ns) channel and different SNR values, averaged after 5000 occasions. FIG. 14 may illustrate the results with a TDL-A (300 ns) channel model, showing nearly identical results to those in TDL-C (300 ns) channel (as shown in FIG. 13).

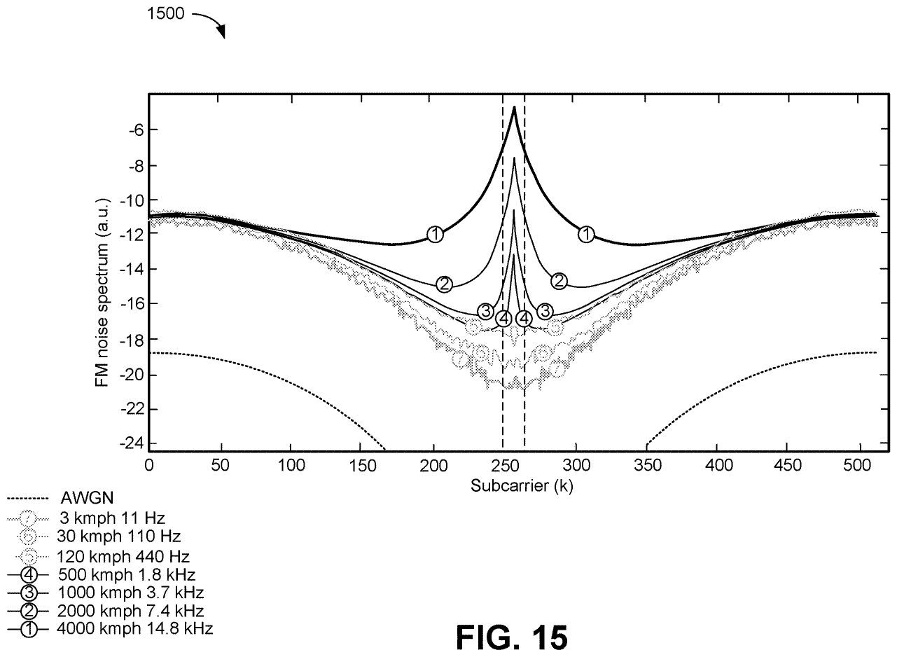

FIG. 15 depicts an example plot 1500 of FM noise power spectrum averaged after 1000 occasions for a Rayleigh flat channel at different velocities, with SNR=20 dB. The magnitude of the central impairment may grow with velocity. Noise floor caused by phase slips may affect area calculations at lower velocities. Threshold extension techniques may alleviate noise floor impact. The parameter 8 used for area calculations may be further optimized to retain most of the area while filtering out some undesired 1/f noise.

What is claimed is:

1. A wireless transmit receive unit (WTRU) comprising a processor and memory, the processor configured to:
receive configuration information, wherein the configuration information indicates:
one or more parameters for a first type of positioning reference signals (PRSs);
one or more parameters for a second type of PRSs; and
a number of consecutive symbols configured for velocity measurements associated with the first type of PRSs;
perform positioning measurements for each of the first type of PRSs and the second type of PRSs;
determine an estimated velocity associated with the WTRU based on a frequency modulated (FM) noise estimation associated with the first type of PRSs over the number of consecutive symbols indicated by the configuration information; and
send a feedback report comprising the positioning measurements for each of the first type of PRSs and second type of PRSs and an indication of the estimated velocity.

2. The WTRU of claim 1, the processor configured to determine the estimated velocity comprises being further configured to:
determine a power spectral density of an instantaneous frequency associated with the first type of PRSs over the number of consecutive symbols indicated by the configuration information; and
determine an accumulated power over a plurality of subcarriers around a central subcarrier associated with the determined power spectral density, wherein the estimated velocity is determined based on the determined accumulated power.

3. The WTRU of claim 1, the processor further configured to:
apply measurements of the first type of PRSs for a positioning measurement under a non-line of sight (NLOS) condition using the determined estimated velocity determined based on the measurements of the first type of PRSs.

4. The WTRU of claim 1, wherein the estimated velocity comprises a relative velocity of the WTRU with respect to a transmit-receive point (TRP).

5. The WTRU of claim 1, wherein the first type of PRSs comprises a pseudo-random sequence of complex modulated symbols and the second type of PRSs comprise a legacy PRSs.

6. The WTRU of claim 1, wherein the number of consecutive symbols of the first type of PRSs configured for velocity measurements are mapped on one or more resource elements (REs) in an up-down and left-right configuration.

7. The WTRU of claim 1, wherein the positioning measurements include one or more of a reference signal time difference (RSTD), a round-trip time (RTT), a reference signal received power per path (RSRPP), a reference signal carrier phase (RSCP), an angle of arrival (AoA), or a Doppler shift.

8. The WTRU of claim 1, wherein the first type of PRSs or the second type of PRSs are sent by respective transmit nodes that are in LOS or NLOS conditions with respect to the WTRU.

9. The WTRU of claim 1, wherein the estimated velocity is determined by the processor being further configured to:
remove pre-existing complex symbols from the first type of PRSs over the number of consecutive symbols indicated by the configuration information;
estimate an amount of FM noise associated with the first type of PRSs over the number of consecutive symbols after removal of the pre-existing complex symbols; and
determine the power spectral density of the FM noise estimation using an absolute squared magnitude of a DFT of an instantaneous frequency associated with the first type of PRSs over the number of consecutive symbols.

10. The WTRU of claim 1, wherein the processor is further configured to:
determine an area estimate based on the positioning measurements for each of the second type of PRSs; and
send the area estimate via the feedback report.

11. A method performed by a wireless transmit receive unit (WTRU), the method comprising:
receiving configuration information, wherein the configuration information indicates: one or more parameters for a first type of positioning reference signals (PRSs);
one or more parameters for a second type of PRSs; and
a number of consecutive symbols configured for velocity measurements associated with the first type of PRSs;
performing positioning measurements for each of the first type of PRSs and the second type of PRSs;
determining an estimated velocity associated with the WTRU based on a frequency modulated (FM) noise estimation associated with the first type of PRSs over the number of consecutive symbols indicated by the configuration information; and
sending a feedback report comprising the positioning measurements for each of the first type of PRSs and second type of PRSs and an indication of the estimated velocity.

12. The method of claim 11, further comprising:
determining a power spectral density of an instantaneous frequency associated with the first type of PRSs over the number of consecutive symbols indicated by the configuration information; and
determining an accumulated power over a plurality of subcarriers around a central subcarrier associated with the determined power spectral density, wherein the estimated velocity is determined based on the determined accumulated power.

13. The method of claim 11, further comprising:
applying measurements of the first type of PRSs for a positioning measurement under a non-line of sight (NLOS) condition using the determined estimated velocity determined based on the measurements of the first type of PRSs.

14. The method of claim 11, wherein the estimated velocity comprises a relative velocity of the WTRU with respect to a transmit-receive point (TRP).

15. The method of claim 1, wherein the first type of PRSs comprises a pseudo-random sequence of complex modulated symbols and the second type of PRSs comprise a legacy PRSs.

16. The method of claim 11, wherein the number of consecutive symbols of the first type of PRSs configured for velocity measurements are mapped on one or more resource elements (REs) in an up-down and left-right configuration.

17. The method of claim 11, wherein the positioning measurements include one or more of a reference signal time difference (RSTD), a round-trip time (RTT), a reference signal received power per path (RSRPP), a reference signal carrier phase (RSCP), an angle of arrival (AoA), or a Doppler shift.

18. The method of claim 11, wherein the first type of PRSs or the second type of PRSs are sent by respective transmit nodes that are in LOS or NLOS conditions with respect to the WTRU.

19. The method of claim 11, further comprising determining the estimated velocity by:
removing pre-existing complex symbols from the first type of PRSs over the number of consecutive symbols indicated by the configuration information;
estimating an amount of FM noise associated with the first type of PRSs over the number of consecutive symbols after removal of the pre-existing complex symbols; and
determining the power spectral density of the FM noise estimation using an absolute squared magnitude of a DFT of an instantaneous frequency associated with the first type of PRSs over the number of consecutive symbols.

20. The method of claim 11, further comprising:
determining an area estimate based on the positioning measurements for each of the second type of PRSs; and
sending the area estimate via the feedback report.
